(19) United States
(12) Patent Application Publication
(10) Pub. No.: US 2010/0063234 A1
(43) Pub. Date: Mar. 11, 2010

(54) METHOD FOR PRODUCTION OF POLYSTER RESIN FILM, AND POLYESTER RESIN FILM, ANTIREFLECTIVE FILM AND DIFFUSION FILM PRODUCED BY THE METHOD

(75) Inventors: Shinichi Nakai, Minami-Ashigara-Shi (JP); Masaaki Otoshi, Minami-Ashigara-Shi (JP); Yasuyuki Maki, Kanagawa (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/593,096

(22) PCT Filed: Mar. 5, 2008
(86) PCT No.: PCT/JP2008/055555

§ 371 Date: Sep. 25, 2009

(30) Foreign Application Priority Data
Mar. 27, 2007 (JP) 2007-082007

(51) Int. Cl. C08F 22/14; B29C 55/00

(52) U.S. Cl. 526/321; 264/210.7

(57) ABSTRACT

One aspect of the present invention provides a method for production of a polyester resin film comprising melt extruding a polyester resin into a sheet shape, cooling and solidifying the polyester resin sheet on a casting drum, then longitudinally stretching the polyester resin sheet in a longitudinal direction, and then passing the longitudinally stretched polyester resin film through a transverse stretching apparatus to transversely stretch the longitudinally stretched polyester resin film in a transverse direction, wherein Xc, Tc, Ts and Te satisfy the formulas of:

Tc≦(Ts+Te)/2+2.66Xc≦Tc+60 (1)

and

2≦Xc≦30 (2),

in which Xc (%) indicates a crystallinity of the film after the longitudinal stretching, Tc (° C.) indicates a crystallization temperature of the film after the longitudinal stretching, Ts (° C.) indicates a film surface temperature at an entrance of a stretching zone of the transverse stretching apparatus, and Te (° C.) indicates a film surface temperature at an exit of the stretching zone of the transverse stretching apparatus.

### TECHNICAL FIELD

The present invention relates to a method for production of a polyester resin film, and particularly to a method for production of a polyester resin film having excellent transparency and applied to optical use, a polyester resin film produced by this production method, and an antireflective film and a diffusion film using this polyester resin film for a substrate.

### BACKGROUND ART

In recent years, the spread of personal computers, particularly, the spread of notebook personal computers with good portability and space-saving desktop personal computers, has been significant. Also, liquid crystal televisions, as slim, big screen televisions for home use, are being spread. With these circumstances, demand for liquid crystal displays increases, and bigger screens are promoted.

As various optical films used for these, for example, an antireflective film is used to prevent that light, such as sunlight, is reflected from a television screen to make the screen difficult to see. This antireflective film is mainly formed as a multilayer in which a transparent thin film of metal oxide is laminated on a transparent support. Also, a diffusion sheet is used for the backlight unit of a liquid crystal display to illuminate the front of the liquid crystal layer with light from the light source. As this diffusion sheet, one in which a light diffusion layer having fine particles of calcium carbonate, silicon dioxide, or the like dispersed is laminated on a transparent support is generally used.

Thus, the optical film is formed by coating a transparent support with each layer. If the transparent support has thickness unevenness, coating unevenness may occur in the subsequent coating step. If coating unevenness occurs, unevenness in the screen occurs due to differences in the intensity of light, therefore, the transparent support preferably has uniform film thickness.

In order to make the film thickness of the transparent support uniform in this manner, Patent Document 1 describes a method for producing a thermoplastic film from a melted resin discharged from a die, using a plurality of cooling drums, characterized in that the temperature of the surface of at least one cooling drum is controlled to be higher than the cooling drum upstream in a direction in which the thermoplastic film moves. Patent Document 1: Japanese Patent Application Laid-Open No. 2006-327160

### DISCLOSURE OF THE INVENTION

### Problems to be Solved by the Invention

However, in recent years, with the spread of notebook personal computers, liquid crystal televisions, and the like, increasingly higher quality has been required for optical films used for these. Therefore, suppression of thickness unevenness by the production method in Patent Document 1 has not been sufficient, and further improvement has been desired.

The present invention has been made in view of such a problem. It is an object of the present invention to provide a method for production of a polyester resin film in which the occurrence of thickness unevenness in the machine direction (MD) is suppressed, a polyester resin film produced by this production method, and an antireflective film and a diffusion film using this polyester resin film for a substrate.

### Means for Solving the Problems

In order to achieve the above object, the first aspect of the present invention provides a method for production of a polyester resin film comprising melt extruding a polyester resin into a sheet shape, cooling and solidifying the polyester resin sheet on a casting drum, then longitudinally stretching the polyester resin sheet in a longitudinal direction, and then passing the longitudinally stretched polyester resin film through a transverse stretching apparatus to transversely stretch the longitudinally stretched polyester resin film in a transverse direction, wherein Xc, Tc, Ts and Te satisfy the formulas of:

Tc≦(Ts+Te)/2+2.66Xc≦Tc+60 (1)

2≦Xc≦30 (2)

in which Xc (%) indicates a crystallinity of the film after the longitudinal stretching, Tc (° C.) indicates a crystallization temperature of the film after the longitudinal stretching, Ts (° C.) indicates a film surface temperature at an entrance of a stretching zone of the transverse stretching apparatus, and Te (° C.) indicates a film surface temperature at an exit of the stretching zone of the transverse stretching apparatus.

According to the first aspect, by the temperature conditions in the stretching zone in which transverse axis stretching is performed, and the crystallinity of the film after longitudinal stretching being in a predetermined range, a phenomenon that thickness unevenness in the machine direction (hereinafter also referred to as “MD thickness unevenness”) is corrected can occur. In other words, in the transverse stretching, MD thickness unevenness can be improved, and uniform film thickness can be obtained. Further, by the crystallinity being in the range of the above (2), the phenomenon that MD thickness unevenness is corrected can be obtained at the maximum. If “(Ts+Te)/2+2.66Xc” in the formula (1) is less than Tc, shrinkage and expansion phenomena occur excessively in the transverse stretching apparatus, and the effect of correcting MD thickness unevenness decreases. If “(Ts+Te)/2+2.66Xc” in the formula (1) is more than Tc+60, on the contrary, the shrinkage and expansion phenomena hardly occur, and also in this case, the effect of correcting MD thickness unevenness decreases.

If Xc in the formula (2) is less than 2, the shrinkage and expansion phenomena occur excessively no matter how the temperature conditions in the transverse stretching apparatus are set, and the effect of correcting MD thickness unevenness decreases. If Xc in the formula (2) is 30 or more, the shrinkage and expansion phenomena hardly occur no matter how the temperature conditions in the transverse stretching apparatus are set, and also in this case, the effect of correcting MD thickness unevenness decreases.

The second aspect of the present invention is characterized in that in the first aspect, the ratio of the longitudinal stretching is 2.0 times or more and 5.0 times or less, and the ratio of the transverse stretching is 2.5 times or more and 5.5 times or less. In the second aspect, the ratio of longitudinal stretching and the ratio of transverse stretching are defined. In the production method of the present invention, the ratio of longitudinal stretching is 2.0 times or more and 5.0 times or less, and the ratio of transverse stretching is 2.5 times or more and 5.5 times or less. By producing in these ranges, MD thickness unevenness can be corrected in transverse stretching in the transverse stretching apparatus. If the longitudinal stretching ratio is less than 2.0 times,

the shrinkage and expansion phenomena occur excessively, and the effect of correcting MD thickness unevenness decreases. If the longitudinal stretching ratio is 5.0 times or more, the shrinkage and expansion phenomena hardly occur, and also in this case, the effect of correcting MD thickness unevenness decreases. In addition, if the transverse stretching ratio is less than 2.5 times, the shrinkage and expansion phenomena do not occur easily, and the effect of correcting MD thickness unevenness decreases. If the transverse stretching ratio is 5.5 times or more, the film breaks easily.

The third aspect of the present invention is characterized in that in the first or second aspect, the film surface temperature at the entrance of the stretching zone of the transverse stretching apparatus, Ts (° C.), is Tg−10° C. or more and Tc+30° C. or less. Tg refers to the glass transition temperature of the polyester resin.

In the third aspect, the film surface temperature at the entrance of the stretching zone of the transverse stretching apparatus is defined. By setting the temperature at the entrance to Tg−10° C. or more and Tc+30° C. or less, because the film can pass through the stretching zone in a state enabling easy stretch, the film can be easily stretched. If the temperature at the entrance is lower than Tg−10° C., because the film is hard and is not easily elongated, the film breaks. If the temperature at the entrance is more than Tc+30° C., because the film is excessively crystallized before stretching, the film is hard and is not easily elongated, therefore, the film breaks.

The fourth aspect of the present invention is characterized in that in the first to third aspects, the film surface temperature at the exit of the stretching zone of the transverse stretching apparatus, Te (° C.), is Tc−20° C. or more and Tc+100° C. or less.

In the fourth aspect, the film surface temperature at the exit of the stretching zone of the transverse stretching apparatus is defined. By the temperature at the exit being Tc−20° C. or more and Tc+100° C. or less, because the film can pass through the stretching zone in a state enabling easy stretch, the film can be easily stretched. If the temperature at the exit is lower than Tc−20° C., the film is not sufficiently crystallized during stretching and hardening of the film does not occur easily, and thickness unevenness is not easily corrected. If the temperature at the exit is higher than Tc+100° C., relaxation of the amorphous part proceeds excessively, the film is softened, and thickness unevenness is not easily corrected.

The fifth aspect of the present invention is characterized in that in the first to fourth aspects, the thickness unevenness of the film after the transverse stretching, for a length of 10 m in the machine direction is 8% or less of film thickness.

According to the fifth aspect, by the thickness unevenness of the film for a length of 10 m being 8% or less of film thickness, a uniform coating film can be formed in the subsequent coating step.

The sixth aspect of the present invention is characterized in that in the first to fifth aspects, the polyester resin is a polyethylene terephthalate resin.

The sixth aspect is particularly effective when the polyester resin is a polyethylene terephthalate resin.

The seventh aspect of the present invention provides a polyester resin film produced by the production method according to any of the first to sixth aspects.

The eighth aspect of the present invention provides an antireflective film characterized in that the polyester resin film according to the seventh aspect is used as a substrate.

The ninth aspect of the present invention provides a diffusion film characterized in that the polyester resin film according to the seventh aspect is used as a substrate.

The polyester resin film obtained by the production method of the present invention has small MD thickness unevenness, and a coating film having uniform film thickness can also be formed in the subsequent coating step, therefore, the polyester resin film can be suitably used as the substrate of an optical film, particularly, as an antireflective film and a diffusion film.

### ADVANTAGES OF THE INVENTION

According to the present invention, by setting the crystallinity of the film after longitudinal stretching and the temperature conditions in the transverse stretching apparatus in a predetermined range, the thickness unevenness in the machine direction of the film can be improved. In addition, because a film having uniform film thickness can be produced, it can be suitably used as a substrate of an optical film, particularly, an antireflective film and a diffusion film.

### BRIEF DESCRIPTION OF THE DRAWINGS

FIG. 1 is a schematic view of an apparatus for production of a polyester resin film;

FIG. 2 is a schematic view of a longitudinal stretching machine which carries out a longitudinal stretching step;

FIG. 3 is a schematic view of a transverse stretching machine which carries out a transverse stretching step;

FIG. 4 is a view showing one example of a graph showing the relationship between heat quantity and temperature; and

FIG. 5 is a table showing the results of the examples.

### DESCRIPTION OF SYMBOLS

10 . . . film production step part
11 . . . die
12 . . . casting drum
20 . . . longitudinal stretching machine
23 . . . heating and stretching roll
24 . . . cooling and stretching roll
30 . . . transverse stretching machine
31 . . . tenter
32 . . . air blocking curtain
40 . . . winder

### BEST MODE FOR CARRYING OUT THE INVENTION

The preferred embodiment of the method for production of a polyester resin film according to the present invention will be described below with reference to the accompanying drawings.

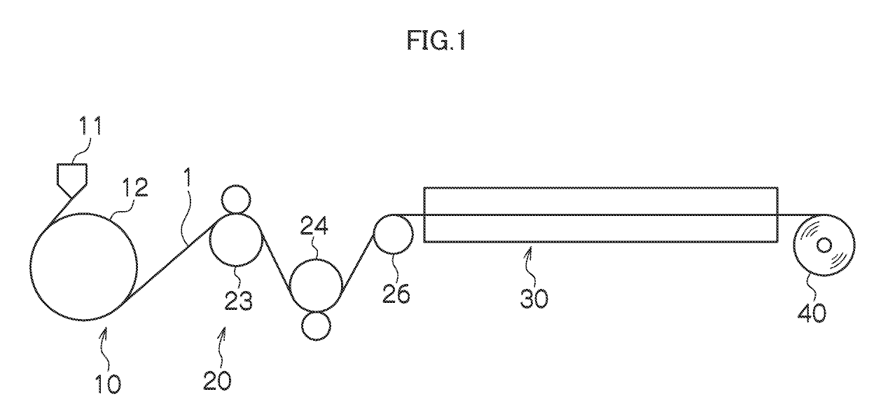

FIG. 1 is a view showing a schematic of an apparatus for production of a polyester resin film. In this view, reference numeral 10 indicates a film production step part in which a polyester resin sheet is produced, reference numeral 20 indicates a longitudinal stretching machine that stretches the polyester resin sheet, produced by this film production step part 10, in the longitudinal direction, reference numeral 30 indicates a transverse stretching machine that stretches the longitudinally stretched polyester resin film, stretched in the longitudinal direction by the longitudinal stretching machine 20, in the transverse direction, and reference numeral 40 indicates a winder that winds the polyester resin film stretched by the transverse stretching machine 30. In the film production step part 10, a die 11 and a casting drum 12 are provided, and the longitudinal stretching machine 20 is provided.

In the present invention, a film after the film production step and before the longitudinal stretching step is referred to as a “polyester resin sheet,” a film after the longitudinal stretching step is referred to as a “longitudinally stretched polyester resin film,” and a film after the transverse stretching step, that is, after biaxial stretching of longitudinal stretching and transverse stretching, is referred to as a “polyester resin film.”

### [Film Production Step]

First, the film production step will be described. A polyester resin is sufficiently dried, then melt extruded into a sheet shape through, for example, an extruder in which temperature is controlled in the range of the melting point+10 to 50° C. (not shown), a filter (not shown), and the die 11, and cast on the rotating casting drum 12 to be quenched and solidified so as to obtain a polyester resin sheet.

### [Longitudinal Stretching Step]

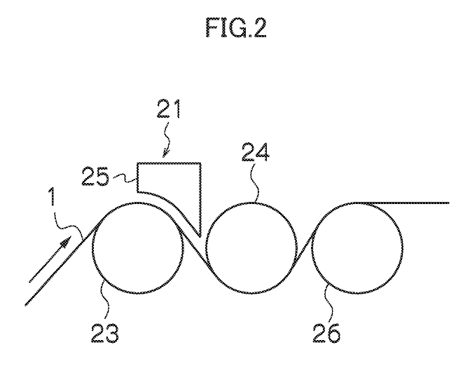

Next, the longitudinal stretching step will be described. The longitudinal stretching machine that carries out the longitudinal stretching step will be described with reference to FIG. 2. FIG. 2 is a schematic view of the longitudinal stretching machine. The longitudinal stretching machine is not limited to the apparatus described in FIG. 2, and an apparatus usually used for longitudinal stretching of a film can also be used. In FIG. 2, in the longitudinal stretching machine 20, a heating and stretching roll 23 and a cooling and stretching roll 24 having different peripheral speed are provided, and a far infrared heater (not shown) is provided above the heating and stretching roll 23. The unstretched polyester resin sheet is longitudinally stretched in the longitudinal stretching step, and then cooled to the glass transition point or less.

The longitudinal stretching step is performed by the longitudinal stretching machine as described above. In this longitudinal stretching step, the far infrared heater is used as means for heating the longitudinally stretched polyester resin film to obtain the longitudinally stretched polyester resin film.

In the longitudinal stretching step, stretching is preferably performed in a manner that the longitudinal stretching ratio is 2.0 times or more and 5.0 times or less. If the longitudinal stretching ratio is less than 2.0 times, because shrinkage and expansion phenomena occur excessively in the transverse stretching step, the effect of correcting MD thickness unevenness decreases, therefore, such a longitudinal stretching ratio is not preferred. If the longitudinal stretching ratio is more than 5.0 times, on the contrary, because shrinkage and expansion effects hardly occur, the effect of correcting MD thickness unevenness decreases, therefore, such a longitudinal stretching ratio is not preferred. The longitudinal stretching ratio is more preferably 2.2 times or more and 4.8 times or less, further preferably 2.4 times or more and 4.5 times or less, and further preferably 2.5 times or more and 4.0 times or less.

The crystallinity of the film after longitudinal stretching, Xc, is 2% or more and 30% or less, preferably 3% or more and 25% or less, more preferably 4% or more and 22% or less, and further preferably 5% or more and 20% or less. By the crystallinity of the film after longitudinal stretching being in the above range, a phenomenon that MD thickness unevenness is corrected can be obtained in the following transverse stretching step. If the crystallinity of the film after longitudinal stretching is less than 2%, the shrinkage and expansion phenomena occur excessively no matter how the temperature conditions in the transverse stretching apparatus are set, and the effect of correcting MD thickness unevenness decreases. If the crystallinity of the film after longitudinal stretching is more than 30%, on the contrary, the shrinkage and expansion phenomena hardly occur no matter how the temperature conditions in the transverse stretching apparatus are set, and the effect of correcting MD thickness unevenness decreases.

The crystallinity can be calculated from the density of the film. In other words, the crystallinity, Xc (%), can be obtained from the following calculation formula, using the density of the film, X (g/cm³), density at a crystallinity of 0%, Yg/cm³, and density at a crystallinity of 100%, Zg/cm³.

Xc={Z×(X−Y)}/{X×(Z−Y)}×100

Measurement of density can be performed according to JIS K7112.

The longitudinally stretched polyester resin film which is longitudinally stretched under the particular conditions as described above is fed to the transverse stretching step and transversely stretched.

### [Transverse Stretching Step]

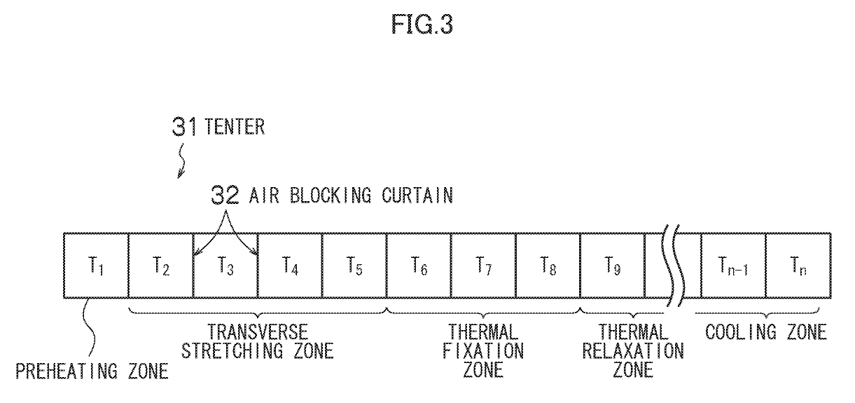

Next, the transverse stretching step will be described. The transverse stretching machine that carries out the transverse stretching step will be described with reference to FIG. 3. FIG. 3 is a schematic view of the transverse stretching machine. In this view, reference numeral 31 indicates a tenter. This tenter 31 comprises many zones that can be individually temperature adjusted by hot air or the like and are divided by air blocking curtains 32, and a preheating zone T₁, transverse stretching zones T₂, T₃, T₄, and T₅, thermal fixation zones T₆, T₇, and T₈, thermal relaxation zones T₉ to Tₙ₋₃, and cooling zones Tₙ₋₂ to Tₙ are located from the entrance.

The transverse stretching step is performed by the transverse stretching machine as described above. In the transverse stretching step, transverse stretching is performed by passing the longitudinally stretched polyester resin film in the tenter, and subjecting the longitudinally stretched polyester resin film to heat in the transverse stretching zones.

For the temperature of transverse stretching, transverse stretching is performed at a temperature that satisfies the following formula (1) when the crystallization temperature of the film after longitudinal stretching is Tc (° C.), the film surface temperature at the entrance of the transverse stretching zone in the tenter 31 (the entrance of T₂ in FIG. 3) is Ts (° C.), and the film surface temperature at the exit of the transverse stretching zone (the exit of T₅ in FIG. 3) is Te (° C.).

Tc≦(Ts+Te)/2+2.66Xc≦Tc+60 (1)

By performing transverse stretching under conditions that satisfy the above formula (1), the phenomenon that MD thickness unevenness is corrected, which depends on MD shrinkage and expansion phenomena occurring in the tenter 31, can be obtained at the maximum. Therefore, the MD thickness unevenness can be improved by the transverse stretching step. The range of the above formula (1) is preferably Tc+10 or more and Tc+55 or less, more preferably Tc+15 or more and Tc+50 or less, and further preferably Tc+20 or more and Tc+45 or less. If the formula (1) is less than Tc, the shrinkage and expansion phenomena occur excessively in the tenter 31, and the effect of correcting MD thickness unevenness decreases. If the formula (1) is more than Tc+60, on the contrary, the shrinkage and expansion phenomena hardly occur, and the effect of correcting MD thickness unevenness decreases.

The film surface temperature at the entrance of the transverse stretching zone, Ts, is preferably Tg−10° C. or more and Tc+30° C. or less, more preferably Tg−5° C. or more and Tc+20° C. or less, further preferably Tg° C. or more and Tc+15° C. or less, and further preferably Tg+5° C. or more and Tc+10° C. or less. By the film surface temperature at the entrance being in the above range, because the film is transversely stretched, being easily elongated, the phenomenon that MD thickness unevenness is corrected can occur during transverse stretching. If the surface temperature at the entrance, Ts, is lower than Tg−10° C., because the film is hard and is not easily elongated, the film breaks. If the surface temperature at the entrance, Ts, is more than Tc+30° C., because the film is excessively crystallized before stretching, the film is hard and is not easily elongated, therefore, the film breaks. Therefore, such surface temperature at the entrance, Ts, is not preferred.

Further, the film surface temperature at the exit of the transverse stretching zone, Te, is preferably Tc−20° C. or more and Tc+100° C. or less, more preferably Tc−10° C. or more and Tc+90° C. or less, further preferably Tc° C. or more and Tc+80° C. or less, and further preferably Tc+10° C. or more and Tc+70° C. or less. By the film surface at the exit being in the above range, because the film can pass through the stretching zone in a state enabling easy stretch, the film can be easily stretched. If the film surface temperature at the exit, Te, is lower than Tc−20° C., the film is not sufficiently crystallized during stretching, so that hardening of the film does not occur easily, and thickness unevenness is not easily corrected. If the film surface temperature at the exit, Te, is more than Tc+100° C., relaxation of the amorphous part proceeds excessively, the film is softened, and thickness unevenness is not easily corrected. Therefore, such film surface temperature at the exit, Te, is not preferred.

Also, in the transverse stretching zones, the transverse stretching ratio is preferably 2.5 times or more and 5.5 times or less. By performing transverse stretching with the ratio in the above range, the MD thickness unevenness can be greatly improved. The transverse stretching ratio is preferably 2.7 times or more and 5.3 times or less, more preferably 2.8 times or more and 5.2 times or less, and further preferably 3.0 times or more and 5.0 times or less. If the transverse stretching ratio is less than 2.5 times, the shrinkage and expansion phenomena do not occur easily, and the effect of correcting MD thickness unevenness decreases. If the transverse stretching ratio is 5.0 times or more, the film breaking limit is reached, and the film breaks.

After transverse stretching in the transverse stretching zones, thermal fixation treatment is performed in the range of the melting point (Tm)−30° C. or more to the melting point (Tm)−5° C. or less, in the thermal fixation zones. If the thermal fixation temperature is less than the melting point (Tm)−30° C., because the polyester resin film cleaves easily, breakage or the like occurs in processing in the subsequent steps, and the polyester resin film can not endure as an optical film. On the other hand, if the thermal fixation temperature is more than the melting point (Tm)−5° C., partial sagging occurs during film conveyance, which is a cause of scratch failure or the like, and production stability is not good.

### [Winding Step]

A polyester resin film having small thickness unevenness and being useful as an optical film can be obtained in the above manner. This polyester resin film is wound by a winder.

A method for measurement of the glass transition point, Tg (° C.), and the crystallization temperature of the film after longitudinal stretching, Tc (° C.), is shown below.

The glass transition point, Tg (° C.), can be measured using, for example, a differential scanning calorimeter, DSC-50 (manufactured by SHIMADZU CORPORATION). In the measurement method, 8 mg of pellets of a polyester resin previously weighed are set in a measurement apparatus, and the temperature is increased to 300° C. at a temperature increase rate of 10° C./min. The peak temperature of the glass transition point at this time is defined as the glass transition temperature, and the glass transition point, Tg (° C.), can be obtained.

The crystallization temperature of the film after longitudinal stretching, Tc (° C.), can also be obtained by a similar measurement apparatus and method. In other words, 8 mg of the film after longitudinal stretching that is previously weighed are set in a measurement apparatus, and the temperature is increased to 300° C. at a temperature increase rate of 10° C./min. The temperature-increase crystallization peak temperature at this time is defined as the crystallization temperature and the crystallization temperature of the film after longitudinal stretching, Tc (° C.), can be obtained.

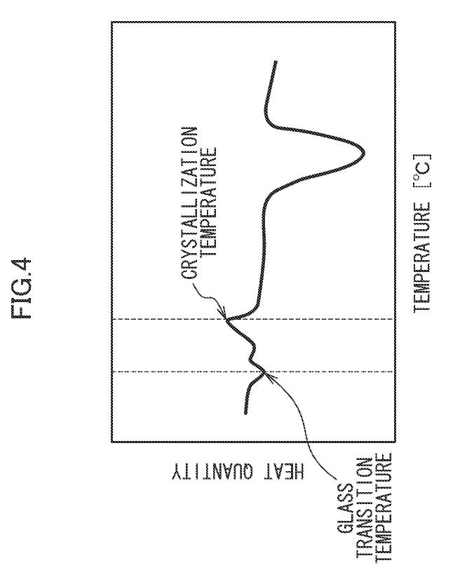

One example of a graph showing the relationship between heat quantity measured using a differential scanning calorimeter and temperature is shown in FIG. 4.

### [Polyester Resin Material]

Next, materials used for the method for production of a polyester resin film according to the present invention will be described. The polyester resin used in the present invention is obtained from diol and dicarboxylic acid by polycondensation. Dicarboxylic acid is represented by terephthalic acid, isophthalic acid, phthalic acid, naphthalenedicarboxylic acid, adipic acid, sebacic acid, and the like. Diol is represented by ethylene glycol, triethylene glycol, tetramethylene glycol, cyclohexanedimethanol, and the like. Specifically, for example, polyethylene terephthalate, polytetramethylene terephthalate, polyethylene-P-oxybenzoate, poly-1,4-cyclohexylene dimethylene terephthalate, polyethylene-2,6-naphthalene dicarboxylate, and the like can be listed, and polyethylene terephthalate is preferably used. These polyesters may be a homopolymer or may be a copolymer of monomers having different components or a blend. The copolymerization components include, for example, diol components, such as diethylene glycol, neopentyl glycol, and polyalkylene glycol, and carboxylic acid components, such as adipic acid, sebacic acid, phthalic acid, isophthalic acid, and 2,6-naphthalenedicarboxylic acid, and the like.

Publicly known catalysts can be used for esterification and transesterification respectively in production of the above polyester. Esterification proceeds even without particularly adding a catalyst. However, because transesterification requires time without a catalyst, the polymer should be maintained at high temperature for long time. As a result, there is inconvenience, for example, thermal degradation occurs. Then, by adding a catalyst as shown below, transesterification can proceed efficiently. For example, as the catalyst for transesterification, manganese acetate, manganese acetate tetrahydrate, cobalt acetate, magnesium acetate, magnesium acetate tetrahydrate, calcium acetate, cadmium acetate, zinc acetate, zinc acetate dihydrate, lead acetate, magnesium oxide, lead oxide, and the like are generally used. These may be used alone or mixed.

The specific resistance (resistivity) of the melt extruded polyester resin is adjusted to 5×10⁶ to 3×10⁸ Ω·cm. If the specific resistance is less than 5×10⁶ Ω·cm, yellowness increases, and the occurrence of foreign substances increases, therefore, such specific resistance is not preferred. If the specific resistance is more than 3×10⁸ Ω·cm, the amount of air inclusion increases, and roughness occurs in the film surface.

Adjustment of this specific resistance of the polyester resin is performed by adjusting the content of the above metal catalyst. Generally, as the metal catalyst content in the polymer is higher, transesterification proceeds faster, and the specific resistance value also decreases. However, if the metal catalyst content is too high, the metal catalyst is not uniformly dissolved in the polymer, which is a cause of occurrence of aggregated foreign substances.

Phosphoric acid and phosphorous acid and their esters, and inorganic particles (silica, kaolin, calcium carbonate, titanium dioxide, barium sulfate, alumina, and the like) may be contained in the polyester resin at the polymerization stage. In addition, inorganic particles and the like may be blended in the polymer after polymerization. Further, a publicly known heat stabilizer, antioxidant, antistatic agent, lubricant, ultraviolet absorber, fluorescent brightening agent, pigment, light blocking agent, filler, and flame retardant, and the like may be added.

### [Polyester Resin Film]

In the polyester resin film produced by the above production method, the thickness unevenness of the film for a length of 10 m in the machine direction is preferably 8% or less of the film thickness, more preferably 6% or less, further preferably 5% or less, and further preferably 4% or less. In the polyester resin film produced by the production method of the present invention, because the phenomenon that MD thickness unevenness is corrected occurs during transverse stretching, the film with thickness unevenness in the above range can be produced.

The thickness unevenness is obtained by the following method. The central portion of the film in the transverse direction is cut out for a length of 10 m in the longitudinal direction, and thickness is measured for each 1 mm in the longitudinal direction. The thickness unevenness is calculated from the following calculation formula, in which Thmax indicates the maximum value of the thickness, Thmin indicates the minimum value, and Thav indicates the average value.

Thickness unevenness=(Thmax−Thmin)/Thav×100

Since the polyester resin film produced by the production method of the present invention has small MD thickness unevenness, when the polyester resin film is used as a substrate, a coating film having uniform film thickness can be formed in the subsequent coating step. Therefore, it can be suitably used as an optical film, particularly, an antireflective film and a diffusion film. The antireflective film is affixed to the front plate (optical filter) of a display, such as a cathode ray tube display (CRT), an LCD, and a PDP, to have the effect of utilizing light interference by the antireflective layer, suppressing the surface reflection and glare of the screen, and reducing reflected light. Also, the diffusion film is one of materials constituting a backlight for liquid crystal, and is a translucent film (sheet or plate) that scatters and diffuses light. The diffusion film is used to uniformly conduct light from the fluorescent tube to the front of the LCD.

### Examples

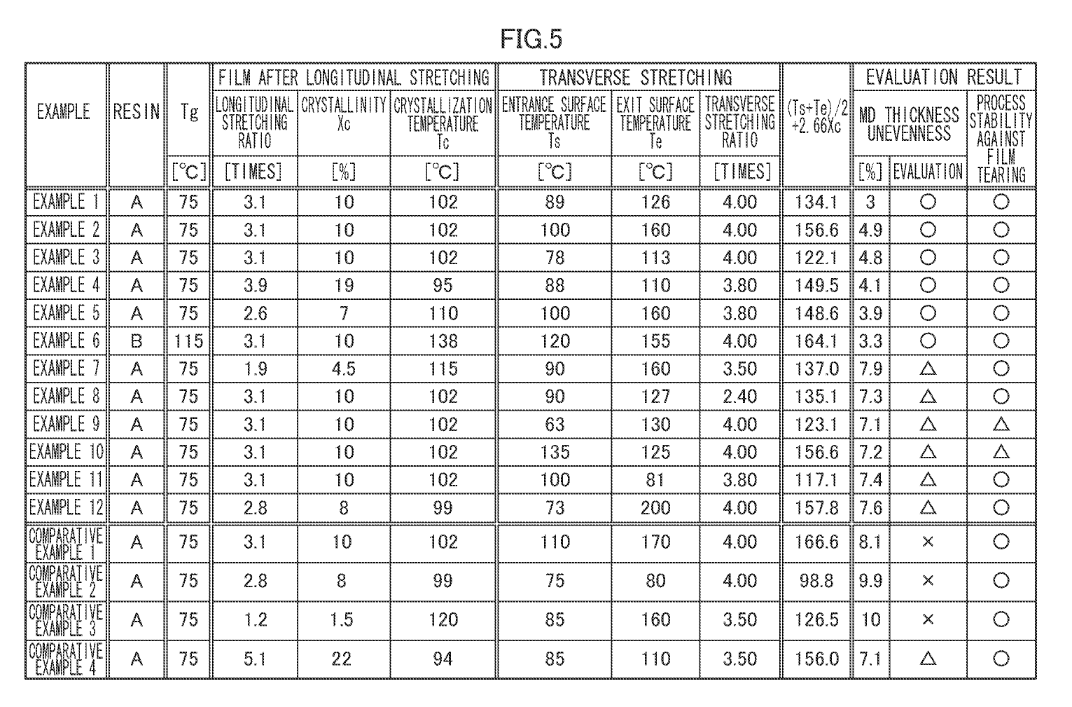

The substantial effect of the present invention will be described below by examples, but the present invention is not limited to these. The test conditions and results of the examples of the present invention are shown in FIG. 5. The raw material of a resin A in FIG. 5 is polyethylene terephthalate, and the raw material of a resin B is polyethylene naphthalate. Evaluation in FIG. 5 was performed according to the following standards.

### <MD Thickness Unevenness>

◯ . . . good (7% or less of the film thickness)
Δ . . . rather bad, but without actual damage, and within an allowable range (7% or more and 8% or less of the film thickness)
x . . . with actual damage (more than 8% of the film thickness)
<Process Stability against Film Tearing>
◯ . . . good
Δ . . . rather bad, but without actual damage, and within an allowable range
x . . . with actual damage

As shown in FIG. 5, in Comparative Examples 1 and 2 not satisfying the formula (1), MD thickness unevenness occurred with more than 8% of the film thickness, and a film at a practical level could not be produced. Also, in Comparative Example 3 with a crystallinity of 1.5%, which is less than 2%, similarly, a film at a practical level could not be produced.

In Examples 1 to 6 in which tests were performed under the conditions of the present invention, films having a good plane shape were produced. In addition, in Examples 7 and 8 with a high or low stretching ratio, occurrence of MD thickness unevenness was seen to some extent, but at a practically insignificant level. Also, in Examples 9 to 12 in which the film surface temperature during transverse stretching was high or low, occurrence of MD thickness unevenness was seen, but at an insignificant level. Also, it was confirmed that by stabilizing temperature at the entrance of the transverse stretching zone, process stability increases.

1-9. (canceled)

10. A method for production of a polyester resin film comprising:
melt extruding a polyester resin into a sheet shape;
cooling and solidifying the polyester resin sheet on a casting drum; longitudinally stretching the polyester resin sheet in a longitudinal direction; and
passing the longitudinally stretched polyester resin film through a transverse stretching apparatus to transversely stretch the longitudinally stretched polyester resin film in a transverse direction, wherein Xc, Tc, Ts and Te satisfy the formulas of:
Tc≦(Ts+Te)/2+2.66Xc≦Tc+60 (1)
2≦Xc≦30 (2)
in which Xc (%) indicates a crystallinity of the film after the longitudinal stretching, Tc (° C.) indicates a crystallization temperature of the film after the longitudinal stretching, Ts (° C.) indicates a film surface temperature at an entrance of a stretching zone of the transverse stretching apparatus, and Te (° C.) indicates a film surface temperature at an exit of the stretching zone of the transverse stretching apparatus.

11. The method for production of a polyester resin film according to claim 10, wherein a ratio of the longitudinal stretching is 2.0 times or more and 5.0 times or less, and a ratio of the transverse stretching is 2.5 times or more and 5.5 times or less.

12. The method for production of a polyester resin film according to claim 10, wherein, when a glass transition temperature of the polyester resin is Tg (° C.), the film surface temperature at the entrance of the stretching zone of the transverse stretching apparatus, Ts (° C.), is Tg−10° C. or more and Tc+30° C. or less.

13. The method for production of a polyester resin film according to claim 10, wherein the film surface temperature at the exit of the stretching zone of the transverse stretching apparatus, Te (° C.), is Tc−20° C. or more and Tc+100° C. or less.

14. The method for production of a polyester resin film according to claim 10, wherein a thickness unevenness of the film after the transverse stretching, for a length of 10 m in a machine direction is 8% or less of film thickness.

15. The method for production of a polyester resin film according to claim 10, wherein the polyester resin is a polyethylene terephthalate resin.

16. A polyester resin film produced by the production method according to claim 10.

17. An antireflective film in which the polyester resin film according to claim 16 is used as a substrate.

18. A diffusion film in which the polyester resin film according to claim 16 is used as a substrate.

19. The method for production of a polyester resin film according to claim 10, wherein, when a glass transition temperature of the polyester resin is Tg (° C.), the film surface temperature at the entrance of the stretching zone of the transverse stretching apparatus, Ts (° C.), is Tg−10° C. or more and Tc+30° C. or less.

20. The method for production of a polyester resin film according to claim 11, wherein the film surface temperature at the exit of the stretching zone of the transverse stretching apparatus, Te (° C.), is Tc−20° C. or more and Tc+100° C. or less.

21. The method for production of a polyester resin film according to claim 12, wherein the film surface temperature at the exit of the stretching zone of the transverse stretching apparatus, Te (° C.), is Tc−20° C. or more and Tc+100° C. or less.

22. The method for production of a polyester resin film according to claim 11, wherein a thickness unevenness of the film after the transverse stretching, for a length of 10 m in a machine direction is 8% or less of film thickness.

23. The method for production of a polyester resin film according to claim 12, wherein a thickness unevenness of the film after the transverse stretching, for a length of 10 m in a machine direction is 8% or less of film thickness.

24. The method for production of a polyester resin film according to claim 13, wherein a thickness unevenness of the film after the transverse stretching, for a length of 10 m in a machine direction is 8% or less of film thickness.
